(19) United States
(12) Patent Application Publication
(10) Pub. No.: US 2005/0271849 A1
(43) Pub. Date: Dec. 8, 2005

(54) Shingled assembly of repositionable devices

(75) Inventors: Jonathan P. Kitchin, Leander, TX (US); Douglas P. Bodziak, Lake Elmo, MN (US); John J. Emmel, Blaine, MN (US); Dwight L. Evans, Cedar Park, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/139,146

(22) Filed: May 27, 2005

Related U.S. Application Data
(60) Provisional application No. 60/585,114, filed on Jul. 2, 2004.
(60) Provisional application No. 60/576,348, filed on Jun. 2, 2004.

(51) Int. Cl. B32B 9/00

(52) U.S. Cl. 428/40.1; 156/297

(57) ABSTRACT

An assembly includes a plurality of repositionable devices. Each repositionable device includes a first major surface and a second major surface opposite the first major surface. A coating of adhesive material is applied on at least a portion of the second major surface of each repositionable device. The repositionable devices are releasably adhered to each other by adhesion of the coating of adhesive material on one repositionable device to portions of the first major surface of an underlying repositionable device. The repositionable devices are arranged in a shingled stack relation.

### CROSS-REFERENCE TO RELATED APPLICATION(S)

This application claims priority from Provisional Application No. 60/585,114 filed Jul. 2, 2004, for “Shingled Assembly of Repositionable Devices” and Provisional Application No. 60/576,348 filed Jun. 2, 2004, for “Adhesive Display Pockets.”

### INCORPORATION BY REFERENCE

The aforementioned U.S. Provisional Application Nos. 60/585,114 and 60/576,348 are hereby incorporated by reference in their entirety.

### BACKGROUND OF THE INVENTION

The present invention relates to repositionable devices, such as protective display devices, tape flags, labels, notes, and the like. In particular, the present invention relates to a system and method for storing and dispensing repositionable devices.

Repositionable devices are quite common in everyday use. These devices typically include a layer of repositionable pressure sensitive adhesive that partially or completely coats one side of the device. Repositionable devices, such as notes, tape flags, labels, and the like, are commonly provided in pad form or in dispenser form. Pads typically comprise a plurality of repositionable devices, the back of which is provided with one or more strips of a low tack adhesive material, enabling individual notes or labels to be removed from the pad and adhesively secured to another surface. Dispensers typically have walls defining a cavity adapted to receive a plurality of repositionable devices and have an opening through which individual repositionable devices are dispensed. A drawback of providing repositionable devices in pad form or dispenser form is that the thickness of the pad or dispenser makes storing or transporting the repositionable devices in systems where a thinner profile is desired less feasible. Such systems include file folders, newspapers, catalogs, magazines, pamphlets, envelopes, pants pockets, wallets, and so on.

Repositionable devices for the display of planar articles, such as photographs, recipe cards, greeting cards, announcements, art work, index cards, and the like are also commonly known. One example of such a device is a sleeve or pocket comprised of a polymeric material. A layer of repositionable adhesive is typically applied to the back surface of the back portion, either along portions of the back surface or covering the entire back surface. The repositionable adhesive permits the device to be adhered to a surface, such as an album page, and thereafter be repositioned on or removed from the surface without marring the surface or leaving significant adhesive residue on the surface.

Sleeves as described are commonly stored, transported, and sold in loose form. Each individual sleeve typically includes a backing of release liner, which is secured to the back surface of the sleeve by the repositionable adhesive. The release liner allows the sleeves to be stored and transported without becoming adhered to one another. When a user wishes to place the sleeve on a surface for display, the release liner must be peeled away from the back surface and subsequently discarded. The use of a release liner in conjunction with each individual sleeve has several drawbacks. For example, because a release liner is provided on every sleeve, a significant amount of waste is produced when the release liner is discarded during the mounting process. Also, the cost to manufacture the sleeves is increased due to the additional materials required for the release liner. Furthermore, removing the liner from each sleeve is time-consuming and requires a certain level of dexterity to initiate removal of the liner from the back surface of the sleeve.

Thus, there is a need in the art for a system for storing and dispensing repositionable devices as described that avoids the drawbacks of the conventional approaches to storing and dispensing heretofore described.

### BRIEF SUMMARY OF THE INVENTION

The present invention is an assembly including a plurality of repositionable devices. Each repositionable device includes a first major surface and a second major surface opposite the first major surface. A coating of adhesive material is applied on at least a portion of the second major surface of each repositionable device. The repositionable devices are releasably adhered to each other by adhesion of the coating of adhesive material on one repositionable device to portions of the first major surface of an underlying repositionable device. The repositionable devices are arranged in a shingled stack relation.

In one embodiment, the shingled stack of repositionable devices is secured to a substrate. The shingled stack of repositionable devices is secured to the substrate by adhering at least a portion of at least one repositionable device in the shingled stack to the substrate. The substrate preferably comprises a sheet of release liner material or a material coated with a release coating.

### BRIEF DESCRIPTION OF THE DRAWINGS

FIG. 1A is a front view of a protective display device.

FIG. 1B is a sectional view along lines 1B-1B in FIG. 1A.

FIG. 2A is a front view of an embodiment of an assembly of protective display devices according to the present invention.

FIG. 2B is a front view of the assembly shown in FIG. 2A, showing a topmost protective display device being removed from the assembly.

FIG. 3 is a front view of an assembly of repositionable notes according to the present invention.

FIG. 4 is a front view of an assembly of repositionable tape flags according to the present invention.

FIG. 5 is a front view of an assembly of labels according to the present invention.

While the above-identified drawings set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principals of this invention. The figures may not be drawn to scale. Like reference numbers have been used throughout the figures to denote like parts.

### DETAILED DESCRIPTION

The present invention is generally directed to providing repositionable devices, such as protective display devices, tape flags, labels, notes, and the like, in a shingled stack relation. As will be appreciated by the following description, arranging repositionable devices in a shingled stack configuration provides several advantages over other dispensing and storage systems. For example, the shingled stack configuration disperses horizontally the thicknesses of each repositionable device, thereby reducing the overall height of the stack. This allows the shingled stack of repositionable devices to be carried, stored, transported, and provided in a system requiring the repositionable devices to have a thin profile. It also improves portability of the repositionable devices and increases product recognition in a sales environment.

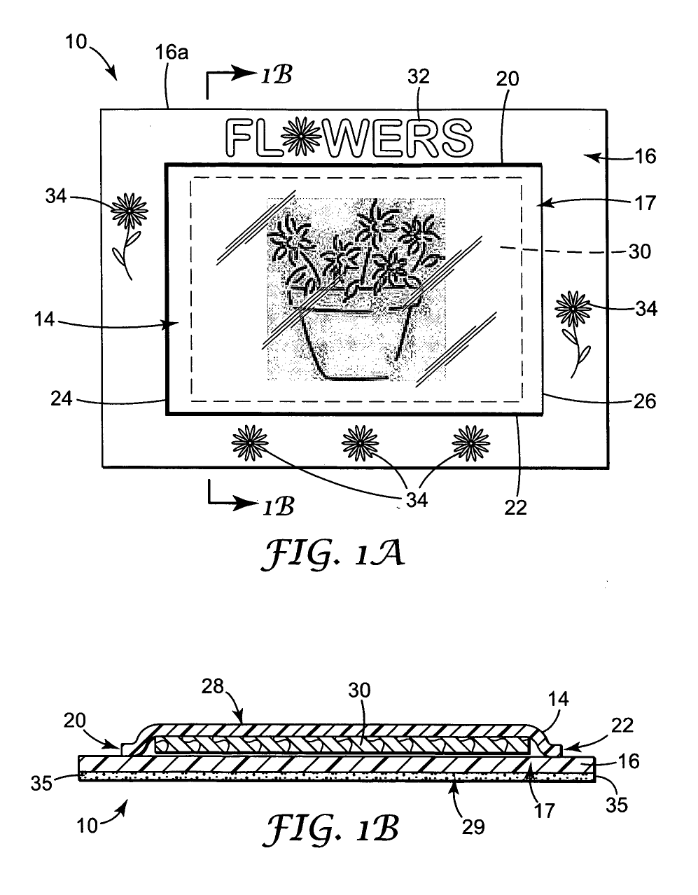

FIG. 1A is a front view and FIG. 1B is a sectional view of a protective display device 10. Protective display device 10 includes front panel 14 and back panel 16. Front panel 14 includes top edge 20, bottom edge 22, and side edges 24 and 26. Front panel 14 is attached to back panel 16 to provide pocket 17 therebetween. Protective display device 10 also includes two major outer surfaces, front surface 28 and back surface 29. Protective display device 10 is shown with substantially planar article 30 (e.g., a photograph) positioned in the pocket 17 between front panel 14 and back panel 16 for mounting and display. Protective display device 10 is for mounting and displaying any article for which protection and display are desirable including, but not limited to, photographs, recipe cards, business cards, greeting cards, announcements, art work, index cards, and the like.

Back panel 16 has a larger surface area than front panel 14. When front panel 14 is attached to back panel 16, a portion 16a of back panel 16 provides a frame around front panel 14 and substantially planar article 30. This framing portion 16a of back panel 16 is not only decorative in and of itself, but it also allows a user to add personalized or decorative print and patterns (for example, text 32 and designs 34) around substantially planar article 30 using a printer or writing utensils, such as pens, pencils, crayons, markers, and the like. This allows for easy personalization of protective display device 10 (and substantially planar article 30).

In one embodiment, front panel 14 and back panel 16 are joined along top edge 20, bottom edge 22, and side edge 24, as shown in FIGS. 1A and 1B. The edges of front panel 14 are joined to back panel 16 using conventional means such as by use of a suitable adhesive, such as a permanent adhesive, a thermally activated adhesive, thermal bonding, or the like. Front panel 14 and back panel 16 remain unjoined along at least side edge 26 to provide an opening through which substantially planar article 30 may be inserted into pocket 17 of protective display device 10.

Front panel 14 may comprise essentially any transparent or colored (translucent) film. Films that are preferably used for front panel 14 include polypropylene, polyester, and polyvinyl chloride, and more preferably biaxially oriented polypropylenes and biaxially oriented polyesters. Back panel 16 may comprise any material capable of being written or printed on to allow personalization along framing portion 16a of protective display device 10 when displaying substantially planar article 30. In one embodiment, back panel 16 is made of a fibrous material such as paper. Furthermore, framing portion 16a of back panel 16 may include a printed or embossed design to produce a decorative appearance around substantially planar article 30 when viewed through front panel 14.

Protective display device 10 is shown with front panel 14 and back panel 16 joined along top edge 20, bottom edge 22, and side edge 24. It will be understood that front panel 14 and back panel 16 may be joined in a variety of configurations provided of course that a substantially planar article placed within protective display device 10 (that is, between front panel 14 and back panel 16) will be retained therein during the course of routine handling and use of protective display device 10. Alternatively, a combination of permanent and repositionable adhesive may be used to adhere all edges of front panel 14 to back panel 16 as long as access to the pocket between front panel 14 and back panel 16 is still possible.

Protective display device 10 typically includes adhesive material 35 on back surface 29 to allow protective display device 10, and substantially planar article 30 positioned therein, to be mounted and displayed on any number of substrates, including albums, scrapbooks, doors, refrigerators, file folders, report covers, and so on. In the embodiment shown, adhesive material 35 completely covers back surface 29, but it will be appreciated that adhesive material 35 may be provided in any configuration on back surface 29. In one embodiment, adhesive material 35 is a repositionable adhesive, which permits protective display device 10 to be adhered to and removed from a variety of substrates multiple times without significant loss of adhesive capability. Alternatively, adhesive material 35 may be a permanent adhesive.

Protective display device 10 is commonly stored, transported, and sold in loose form in packages containing a plurality of protective display devices 10. In order to prevent the plurality of protective display devices 10 from becoming adhered to one another, each individual protective display device 10 typically includes a backing of release liner material, which is secured to back surface 29 of protective display device 10 via adhesive material 35. When a user wishes to place protective display device 10 on a surface for display, the release liner must be peeled away from back surface 29 and subsequently discarded. An example of a protective display device including a layer of release liner on each individual device as described is disclosed in, for example, U.S. Pat. No. 4,771,557, entitled “Transparent Pocket for Mounting Display Items and Method for Manufacturing Same.”

The use of a release liner in conjunction with each individual protective display device 10 has several drawbacks. For example, because a release liner is provided on every protective display device 10, a significant amount of waste is produced when the release liner is discarded during the mounting process. Also, the cost to manufacture protective display devices 10 is increased due to the additional materials required for the release liner. In addition, removing the release liner from each protective display device 10 is time-consuming, and requires a certain level of dexterity to initiate removal of the release liner from the back surface of protective display device 10.

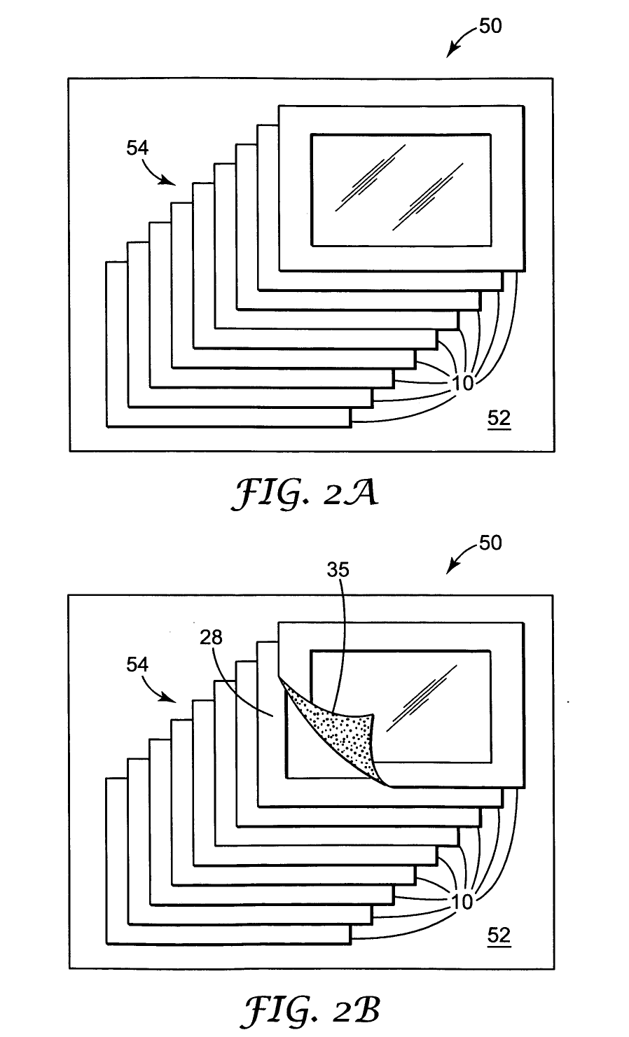

FIG. 2A is a front view of assembly 50 according to an embodiment of the present invention. Assembly 50 includes a plurality of protective display devices 10 and substrate 52. Protective display devices 10 each include an adhesive material on at least a portion of back surface 29 of back panel 16. Preferably, the adhesive material completely coats back surface 29. The adhesive material applied to back surface 29 is a repositionable adhesive, which permits protective display device 10 to be adhered to and removed from a variety of substrates multiple times without significant loss of adhesive capability. The repositionable adhesive is preferably a repositionable microsphere pressure sensitive adhesive, for example as described in U.S. Pat Nos. 5,571,617, 5,045,569, 4,495,318, 4,166,152, 3,857,731, and 3,691,140.

Protective display devices 10 are arranged to form shingled stack 54. Shingled stack 54 is formed by releasably adhering protective display devices 10 to each other by adhesion of the coating of adhesive material on back surface 29 of one protective display device 10 to portions of front surface 28 of front panel 14 of an underlying protective display device 10. Shingled stack 54 is secured to substrate 52 by adhering at least a portion of at least one protective display device 10 in shingled stack 54 to substrate 52. In one embodiment, back surface 29 of protective display device 10 at the bottom of shingled stack 54 is completely secured to substrate 52, and the exposed portions of the adhesive material on the remaining protective display devices 10 are also secured to substrate 52. Optionally, a coating of release material may be applied on front surface 28 of each protective display device 10 to improve releasability of each protective display device 10 from shingled stack 54.

Substrate 52 is a sheet of material with properties that increase the releasability of protective display devices 10 from substrate 52. Preferably, substrate 52 is a sheet of release liner material, which is typically a sheet of paper coated in a release coating. The release coating may be of any known materials used for their release properties for adhesives. Preferred types are silicones and modified silicones, the modification including both copolymerization of silicones with other non-release chemical agents or by adding non-silicone materials to the silicone coating solution prior to application to the base paper of the release liner. Other release agents such as polyethylene, fluorocarbons, the Werner-type chromium complexes, and polyvinyl octadecyl carbamate may also be used. The choice of release coating is dependent on the tack, adhesion level, and chemical nature of the adhesive material on back surface 29. Alternatively, substrate 52 may be comprised of a material (e.g., a polymer) coated by a release coating.

FIG. 2B is a front view of the assembly shown in FIG. 2A, showing protective display device 10 at the top of shingled stack 54 being removed from assembly 50. Protective display device 10 is removed from shingled stack 52 by lifting a corner or edge of protective display device 10 at the top of shingled stack 54, and subsequently releasing adhesive 35 of protective display device 10 at the top of shingled stack 54 from front surface 28 of protective display device 10 immediately beneath in shingled stack 54. Adhesive 35 is such that no residue is left on front surface 28 of the underlying protective display device 10 when protective display device 10 at the top of shingled stack 54 is removed. When protective display device 10 has been removed from the top of shingled stack 54, it may be mounted on a desired surface for display.

By arranging protective display devices 10 in a shingled stack configuration, several advantages over the prior art are achieved. For example, the shingled stack configuration allows for the elimination of the conventional release liner. This not only reduces waste, but also allows for time-efficient and convenient dispensing of protective display devices 10, since the step of removing the release liner is eliminated from the mounting process. In addition, the cost of manufacture is reduced because only a single substrate is required for a plurality of protective display devices 10, as opposed to a sheet of liner on each individual release liner 10. Furthermore, the shingled stack configuration disperses horizontally the thicknesses of each protective display device 10, thereby reducing the overall height of the stack. Moreover, protective display devices 10 are more easily transportable via assembly 50, rather than loosely as individual protective display devices 10 with a release liner.

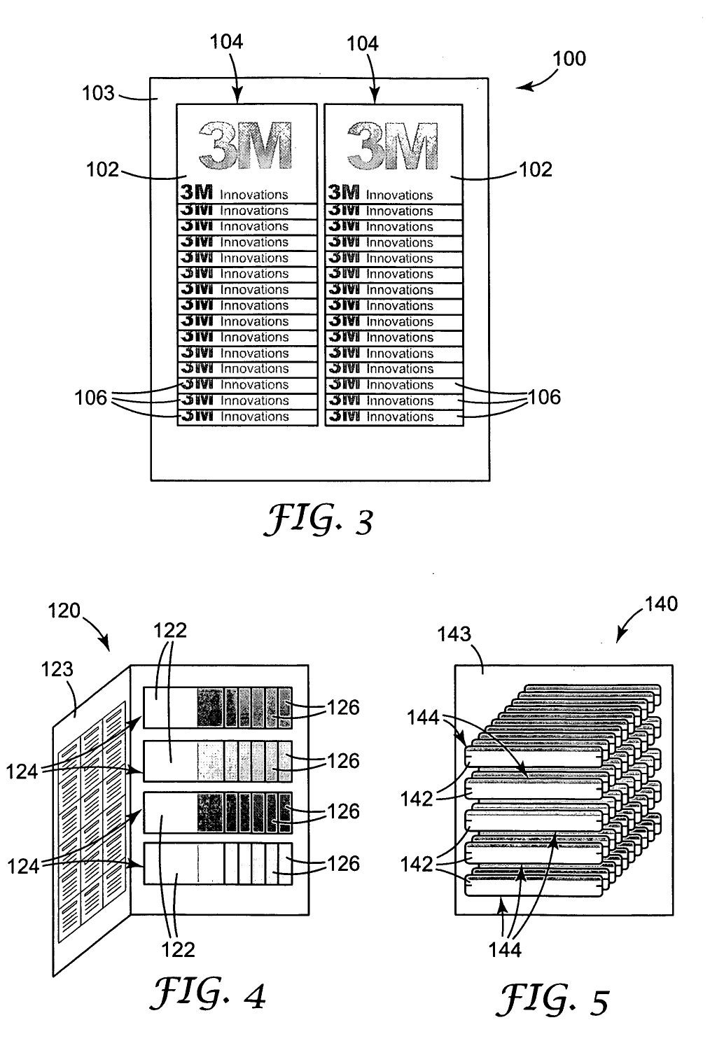

The assembly shown in FIGS. 2A and 2B include shingled arrangements of protective display devices 10. It should be noted that a shingled configuration of a plurality of any type of repositionable device is contemplated by the present invention. For example, FIG. 3 is a front view of assembly 100 according to the present invention including a plurality of repositionable notes 102, such as the Post-it® brand notes sold by 3M Company of St. Paul, Minn. Assembly 100 also includes substrate 103. Repositionable notes 102 each include an adhesive material on at least a portion of its back surface. Preferably, the adhesive material is provided in one or more strips of repositionable adhesive, which permits repositionable note 102 to be adhered to and removed from a variety of substrates multiple times without significant loss of adhesive capability. The repositionable adhesive is preferably a repositionable microsphere pressure sensitive adhesive, for example as described in the U.S. patents listed above.

Repositionable notes 102 are arranged to form shingled stack 104. Shingled stack 104 is formed by releasably adhering repositionable notes 102 to substrate 103 and to each other by adhesion of the coating of adhesive material on the back surface of one repositionable note 102 to portions of the front surface of an underlying repositionable note 102. Shingled stack 104 is secured to substrate 103 by adhering at least a portion of at least one repositionable note 102 in shingled stack 104 to substrate 103.

Substrate 103 may be any material to which the repositionable pressure sensitive adhesive on repositionable note 102 adheres. For example, substrate 103 may be a newspaper, catalog, magazine, pamphlet, envelope, and so on. Substrate 103 may also include a release coating to increase the releasability of repositionable notes 102 from substrate 103. The release coating may be of any known materials used for their release properties for adhesives.

Exposed portion 106 of each underlying repositionable note 102 preferably remains uncovered (that is, not overlapped) to allow easy removal of each repositionable note 102 from shingled stack 104. Further, by leaving exposed portion 106 of each underlying repositionable note 102 uncovered, assembly 100 may be introduced into a commercial or consumer level printer to print text or designs on the exposed portion. This allows a user to easily personalize repositionable notes 102 by printing, for example, personal names, company names, adages, company logos, sports team logos, monograms, ornate designs, and so on, on exposed portion 106. To further personalize assembly 100, various text or designs may also be printed on substrate 103 around shingled stacks 104.

FIG. 4 is a front view of assembly 120 according to the present invention including a plurality of repositionable tape flags 122, such as the Post-it® brand flags sold by 3M Company of St. Paul, Minn. Assembly 120 also includes substrate 123. Tape flags 122 are preferably made of a flexible polymeric material (e.g., polyester) having a coating of adhesive material on a portion of its back surface. Preferably, the adhesive material is a repositionable pressure sensitive adhesive provided on a back surface of each tape flag 122, while leaving tab portion 126 free of adhesive material. This permits tape flag 122 to be adhered to and removed from a variety of substrates multiple times without significant loss of adhesive capability. The repositionable adhesive is preferably a repositionable microsphere pressure sensitive adhesive, for example as described in the U.S. patents listed above.

Tape flags 122 are arranged to form shingled stack 124. Shingled stack 124 is formed by releasably adhering tape flags 122 to substrate 123 and to each other by adhesion of the coating of adhesive material on the back surface of one tape flag 122 to portions of the front surface of an underlying tape flag 122. Shingled stack 124 is secured to substrate 123 by adhering at least a portion of at least one tape flag 122 in shingled stack 124 to substrate 123. Tab portion 126 of each tape flag 122 preferably remains uncovered (that is, not overlapped) to allow easy removal of each tape flag 122 from shingled stack.

Substrate 123 may be any material to which the repositionable pressure sensitive adhesive on tape flag 122 adheres. For example, substrate 123 may be a newspaper, catalog, magazine, pamphlet, envelope, and so on. In FIG. 7, substrate 123 is shown as a pocket or wallet calendar. Substrate 123 may also include a release coating to increase the releasability of tape flags 122 from substrate 123. The release coating may be of any known materials used for their release properties for adhesives.

FIG. 5 is a front view of assembly 140 according to the present invention including a plurality of labels 142, such as file folder labels. Assembly 140 also includes substrate 143. Labels 142 include a coating of adhesive material on at least a portion of its back surface (typically, an entire back surface of label 142 is coated with adhesive material). Preferably, the adhesive material is a repositionable pressure sensitive adhesive provided on the back surface of label 142. The use of a repositionable pressure sensitive adhesive permits label 142 to be adhered to and removed from a variety of substrates multiple times without significant loss of adhesive capability. The repositionable adhesive is preferably a repositionable microsphere pressure sensitive adhesive, for example as described in U.S. patents listed above.

Labels 142 are arranged to form shingled stack 144. Shingled stack 144 is formed by releasably adhering labels 142 to substrate 143 and to each other by adhesion of the coating of adhesive material on the back surface of one label 142 to portions of the front surface of an underlying label 142. Shingled stack 144 is secured to substrate 143 by adhering at least a portion of at least one label 142 in shingled stack 144 to substrate 143.

Substrate 143 may be any material to which the repositionable pressure sensitive adhesive on label 142 adheres. For example, substrate 143 may be a newspaper, magazine, catalog, pamphlet, envelope, and so on. Substrate 143 may also include a release coating to increase the releasability of labels 142 from substrate 143. The release coating may be of any known materials used for their release properties for adhesives. Preferred types are silicones and modified silicones, the modification including both copolymerization of silicones with other non-release chemical agents or by adding non-silicone materials to the silicone coating solution prior to application to the base paper of the release liner. Other release agents such as polyethylene, fluorocarbons, the Werner-type chromium complexes, and polyvinyl octadecyl carbamate may also be used. The choice of release coating is dependent on the tack, adhesion level, and chemical nature of the adhesive material on the back surface of each label 142.

By arranging repositionable notes 102, tape flags 122, and labels 142 in a shingled stack configuration, several advantages over the prior art are achieved. For example, the shingled stack configuration disperses horizontally the thicknesses of each repositionable device, thereby reducing the overall height of the stack. This allows the shingled stack of repositionable devices to be carried, stored, transported, and provided in a system requiring the repositionable devices to have a thin profile. It also improves portability of the repositionable devices and increases product recognition in a sales environment. Furthermore, by leaving a portion of each repositionable device uncovered or exposed, the assembly of repositionable devices may be introduced into a commercial or consumer level printer to print text or designs on the exposed portion. This feature, which is not available to repositionable devices provided in pad or dispenser form, allows a user to easily personalize the repositionable devices.

Various modifications to the assemblies of repositionable devices heretofore described may be made without departing from the spirit and scope of the present invention. For example, the shingled arrangements of the repositionable devices shown in the figures are merely exemplary, and any shingled configuration of repositionable devices may be provided without departing from the spirit and scope of the present invention. Essentially, the repositionable devices are arranged in a shingled arrangement to reduce the thickness profile of the assembly, to improve portability of the repositionable devices, and to increase product recognition in a sales environment. Also, the repositionable devices shown in the figures are merely exemplary, and any repositionable devices provided in a shingled arrangement are contemplated by the present invention. Other repositionable devices which may be provided in a shingled stack relation include tape strips, adhesive bandages, pharmaceutical patches, sterilizing strips, sandpaper (with adhesive backing), stickers, stamps, business cards, and so on. Furthermore, any combinations of different repositionable devices provided in a shingled stack relation may be provided on a single substrate. Moreover, the repositionable devices may include various other types of adhesive including, for example, pressure sensitive adhesive and permanent adhesive.

In summary, conventional systems for storing and dispensing repositionable devices, such as protective display devices, notes, tape flags, labels, and the like, suffer from several drawbacks including increased waste, increased cost, and increased thickness when presented in pad or dispenser form. The present invention is an assembly including a plurality of repositionable devices to overcome these drawbacks. Each repositionable device includes a first major surface and a second major surface opposite the first major surface. A coating of adhesive material is applied on at least a portion of the second major surface of each repositionable device. The repositionable devices are releasably adhered to each other by adhesion of the coating of adhesive material on one repositionable device to portions of the first major surface of an underlying repositionable device. The repositionable devices are arranged in a shingled stack relation, and preferably mounted on a substrate.

Although the present invention has been described with reference to preferred embodiments, workers skilled in the art will recognize that changes may be made in form and detail without departing from the spirit and scope of the invention.

1. An assembly comprising:
a plurality of repositionable devices, each repositionable device having a first major surface and a second major surface opposite the first major surface; and
a coating of adhesive material on at least a portion of the second major surface of each repositionable device,
wherein the repositionable devices are releasably adhered to each other by adhesion of the coating of adhesive material on one repositionable device to portions of the first major surface of an underlying repositionable device, and
wherein the repositionable devices are arranged in a shingled stack relation.

2. The assembly of claim 1, and further comprising:
a substrate, wherein the shingled stack of repositionable devices is secured to the substrate.

3. The assembly of claim 2, wherein the shingled stack is secured to the substrate by exposed adhesive material on the second major surface of at least one of the repositionable devices in the shingled stack to the substrate.

4. The assembly of claim 2, wherein the substrate comprises a sheet of release liner material.

5. The assembly of claim 2, wherein the substrate comprises a layer of material coated with a release coating.

6. The assembly of claim 1, wherein the adhesive material is a pressure sensitive adhesive.

7. The assembly of claim 6, wherein the pressure sensitive adhesive is a repositionable pressure sensitive adhesive.

8. The assembly of claim 1, wherein at least a portion of the first major surface on each repositionable device is printable.

9. The assembly of claim 1, and further comprising:
a coating of release material on the first major surface of each repositionable device to improve releasability of each repositionable device from the shingled stack.

10. The assembly of claim 1, wherein the repositionable devices are selected from the group consisting of protective display devices, repositionable notes, tape flags, and labels.

11. The assembly of claim 1, wherein each repositionable device comprises a protective display device for receiving and retaining a substantially planar article, the protective display device comprising:
a front panel having a top edge, a bottom edge, a first side edge, and a second side edge; and
a back panel having a larger surface area than the front portion and comprising a writable material,
wherein the front panel and back panel are joined to form a pocket into which the substantially planar article can be inserted, the pocket is defined by edges of the front panel, and the back panel provides a framed appearance around the front panel.

12. The assembly of claim 11, wherein each protective display device comprises a transparent polymeric material.

13. The assembly of claim 12, wherein the transparent polymeric material is selected from the group consisting of polypropylene, polyester, and polyvinyl chloride.

14. A method of assembling a plurality of repositionable devices, each repositionable device having first and second major surfaces, the method comprising:
applying an adhesive material to a second major surface of each repositionable device; and
releasably adhering the repositionable devices to each other by adhesion of the coating of adhesive material to portions of the first major surface of an underlying repositionable device to form a shingled stack of repositionable devices.

15. The method of claim 14, and further comprising:
securing the shingled stack of repositionable devices on a substrate.

16. The method of claim 15, wherein securing the shingled stack of repositionable devices on a substrate comprises adhering at least a portion of at least one repositionable device in the shingled stack to the substrate.

17. The method of claim 14, wherein the substrate comprises a sheet of release liner material.

18. The method of claim 14, wherein the substrate comprises a material coated with a release coating.

19. The method of claim 14, wherein the adhesive material is a pressure sensitive adhesive.

20. The method of claim 19, wherein the pressure sensitive adhesive is a repositionable pressure sensitive adhesive.

21. The method of claim 14, and further comprising:
printing on at least a portion of the first repositionable device in the shingled stack.

22. The method of claim 14, and further comprising:
applying a release material to the first major surface of each repositionable device to improve releasability of each repositionable device from the shingled stack.

23. The method of claim 14, wherein the repositionable devices are selected from the group consisting of protective display devices, repositionable notes, tape flags, tape strips, and labels.

24. The method of claim 14, wherein each repositionable device comprises a protective display device for receiving and retaining a substantially planar article, the protective display device comprising:
a front panel having a top edge, a bottom edge, a first side edge, and a second side edge; and
a back panel having a larger surface area than the front portion and comprising a writable material,
wherein the front panel and back panel are joined to form a pocket into which the substantially planar article can be inserted, the pocket is defined by edges of the front panel, and the back panel provides a framed appearance around the front panel.

25. A method of dispensing a plurality of substantially planar devices, each planar device having first and second major surfaces, the method comprising:
applying an adhesive material to the second major surface of each substantially planar device;
arranging the substantially planar devices in a shingled stack relation;
releasably adhering the substantially planar devices to each other by adhesion of the coating of adhesive material on one substantially planar device to portions of the first major surface of an underlying substantially planar device; and
securing the shingled stack of substantially planar devices on a substrate.

26. The method of claim 25, wherein securing the shingled stack of substantially planar devices on a substrate comprises adhering at least a portion of at least one substantially planar device in the shingled stack to the substrate.

27. The method of claim 25, and further comprising:
applying a release material to the first major surface of each substantially planar device to improve releasability of each substantially planar device from the shingled stack.

28. The method of claim 25, wherein the adhesive material is a pressure sensitive adhesive.

29. The method of claim 28, wherein the pressure sensitive adhesive is a repositionable pressure sensitive adhesive.

30. The method of claim 25, and further comprising:
printing on at least a portion of the first major surface of each substantially planar device in the shingled stack.
